(19) United States
(12) Patent Application Publication
(10) Pub. No.: US 2018/0159867 A1
(43) Pub. Date: Jun. 7, 2018

(54) DATA PROTECTION METHOD AND DATA PROTECTION SYSTEM

(71) Applicant: INSTITUTE FOR INFORMATION INDUSTRY, TAIPEI (TW)

(72) Inventors: Wei-Chao HSU, Taipei City (TW); Fu-Hau HSU, Taichung City (TW); Ting LUO, Pingtung County (TW); Chi-Yu YOU, New Taipei City (TW)

(21) Appl. No.: 15/371,182

(22) Filed: Dec. 6, 2016

(30) Foreign Application Priority Data
Dec. 1, 2016 (TW) 105139741

(51) Int. Cl. H04L 29/06; G06F 21/60

(52) U.S. Cl. CPC H04L 63/1416; G06F 21/60; H04L 63/1441

(57) ABSTRACT

A data protection method includes: detecting whether a web transmission behavior occurs or not; analyzing a transmitter and a first file of the web transmission behavior, wherein the transmitter is corresponding to a first application program, and the first file is corresponding to a first file characteristic; extracting a historical accessing record of the transmitter from a memory; extracting a second file characteristic of a second file from the memory in a state that the historical accessing record indicates that the transmitter accesses the second file of a second application program; comparing the first file characteristic with the second file characteristic, to generate a first similarity degree; and blocking the web transmission behavior according to the first similarity degree.

### RELATED APPLICATIONS

This application claims priority to Taiwanese Application Serial Number 105139741, filed Dec. 1, 2016, which is herein incorporated by reference.

### BACKGROUND

### Technical Field

The present disclosure relates to a data protection technology. More particularly, the present disclosure relates to a data protection method and a data protection system.

### Description of Related Art

With the development of mobile devices, data processed by a mobile device is gradually increasing. Several application programs (APPs) may be installed in one mobile device. If one of the APPs is a malicious program, the probability that data of other APPs on the same mobile device is stolen by this malicious program is very high.

### SUMMARY

One embodiment of the present disclosure is related to a data protection method. The data protection method includes the steps: detecting whether a web transmission behavior occurs or not by a processor; analyzing a transmitter and a first file of the web transmission behavior by the processor, wherein the transmitter is corresponding to a first application program, and the first file is corresponding to a first file characteristic; extracting a historical accessing record of the transmitter from a memory by the processor; extracting a second file characteristic of a second file from the memory, by the processor, in a state that the historical accessing record indicates that the transmitter accesses the second file of a second application program; comparing the first file characteristic with the second file characteristic, by the processor, to generate a first similarity degree; and blocking the web transmission behavior according to the first similarity degree by the processor.

Another embodiment of the present disclosure is related to a data protection system. The data protection system includes a memory and a processor. The processor is coupled to the memory. The processor is configured to detect whether a web transmission behavior occurs or not. The processor is further configured to analyze a transmitter and a first file of the web transmission behavior. The transmitter is corresponding to a first application program and the first file is corresponding to a first file characteristic. The processor is further configured to extract a historical accessing record of the transmitter from a memory. The processor is further configured to extract a second file characteristic of a second file from the memory in a state that the historical accessing record indicates that the transmitter accesses the second file of a second application program. The processor is further configured to compare the first file characteristic with the second file characteristic to generate a first similarity degree. The processor is further configured to block the web transmission behavior according to the first similarity degree.

Yet another embodiment of the present disclosure is related to a non-transitory computer readable storage medium storing a computer program. The computer program is configured to execute a data protection method. The data protection method includes the steps: detecting whether a web transmission behavior occurs or not by; analyzing a transmitter and a first file of the web transmission behavior, wherein the transmitter is corresponding to a first application program, and the first file is corresponding to a first file characteristic; extracting a historical accessing record of the transmitter from a memory; extracting a second file characteristic of a second file from the memory in a state that the historical accessing record indicates that the transmitter accesses the second file of a second application program; comparing the first file characteristic with the second file characteristic, to generate a first similarity degree; and blocking the web transmission behavior according to the first similarity degree.

As the above embodiments, in the data protection method and the data protection system of this disclosure, the processor compares the first file characteristic with the second file characteristic in a state that the web transmission behavior is detected. The processor blocks the web transmission behavior in a state that the first file characteristic is similar to the second file characteristic. Thus, the first file suspected to be the second file is prevented from being transmitted through the web by the first application program.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating a data protection system according to some embodiments of the present disclosure;

FIG. 2 is a flow diagram illustrating a data protection method according to some embodiments of this disclosure;

FIG. 3 is a flow diagram illustrating a data protection method according to some embodiments of this disclosure; and

FIG. 4 is a flow diagram illustrating a data protection method according to some embodiments of this disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. The embodiments below are described in detail with the accompanying drawings, but the examples provided are not intended to limit the scope of the disclosure covered by the description. The structure and operation are not intended to limit the execution order. Any structure regrouped by elements, which has an equal effect, is covered by the scope of the present disclosure.

Moreover, the drawings are for the purpose of illustration only, and are not in accordance with the size of the original drawing. The components in description are described with the same number to understand.

As used herein, “coupled” may refer to two or more elements are in “direct” physical or electrical contact made, or “indirectly”, as a mutual entity or electrical contact, and may also refer to two or more elements are operating or action.

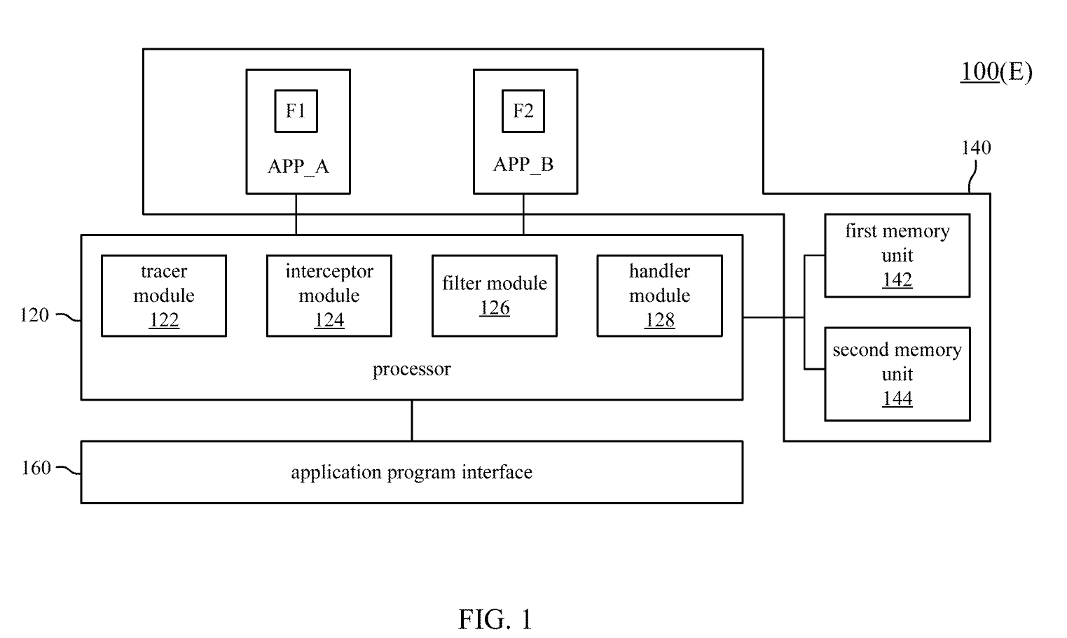

Reference is made to FIG. 1. FIG. 1 is a schematic diagram illustrating a data protection system 100 according to some embodiments of the present disclosure. As illustratively shown in FIG. 1, the data protection system 100 includes a processor 120 and a memory 140. The processor 120 is coupled to the memory 140.

In some embodiments, the data protection system 100 is implemented into a mobile electronic device E. The mobile electronic device E is, for example, a smart phone, a tablet, or various mobile devices having web transmission function. In some embodiments, the mobile electronic device E is a smart phone running iOS or Android.

In some embodiments, the processor 120 is a central processing unit (CPU), a micro-processor, a processing circuit, or other hardware elements which are able to execute instructions, but is not limited thereto.

In some embodiments, the processor 120 includes a tracer module 122, an interceptor module 124, a filter module 126, and a handler module 128. Above-mentioned modules may be implemented in terms of software, hardware and/or firmware. For example, if the execution speed and accuracy have priority, the above-mentioned modules may be implemented in terms of hardware and/or firmware. If the design flexibility has higher priority, then the above-mentioned modules may be implemented in terms of software. Furthermore, the above-mentioned modules may be implemented in terms of software, hardware and firmware in the same time.

In some embodiments, the memory 140 includes a first memory unit 142 and a second memory unit 144. The first memory unit 142 is configured to store a plurality of historical accessing records. The second memory unit 144 is configured to store a plurality of file characteristics corresponding to a plurality of files. The type of the files characteristics is not limited in this disclosure. Various types of the files characteristics are in the scope of this disclosure. For example, a file characteristic of a file may be the content of the first N bytes of the file, and N is a positive integer.

In some embodiments, the data protection system 100 further includes an application program APP_A and an application program APP_B. In some embodiments, the application program APP_A and the application program APP_B are installed in the memory 140. In some embodiments, data of the application program APP_A and data of the application program APP_B are stored in different storing blocks of the memory 140 respectively. In some embodiments, the mobile electronic device E includes more than two application programs.

In some embodiments, the data protection system 100 further includes an application program interface (API) 160. In operation, the application program APP_A communicates with the application program APP_B through the application program interface 160.

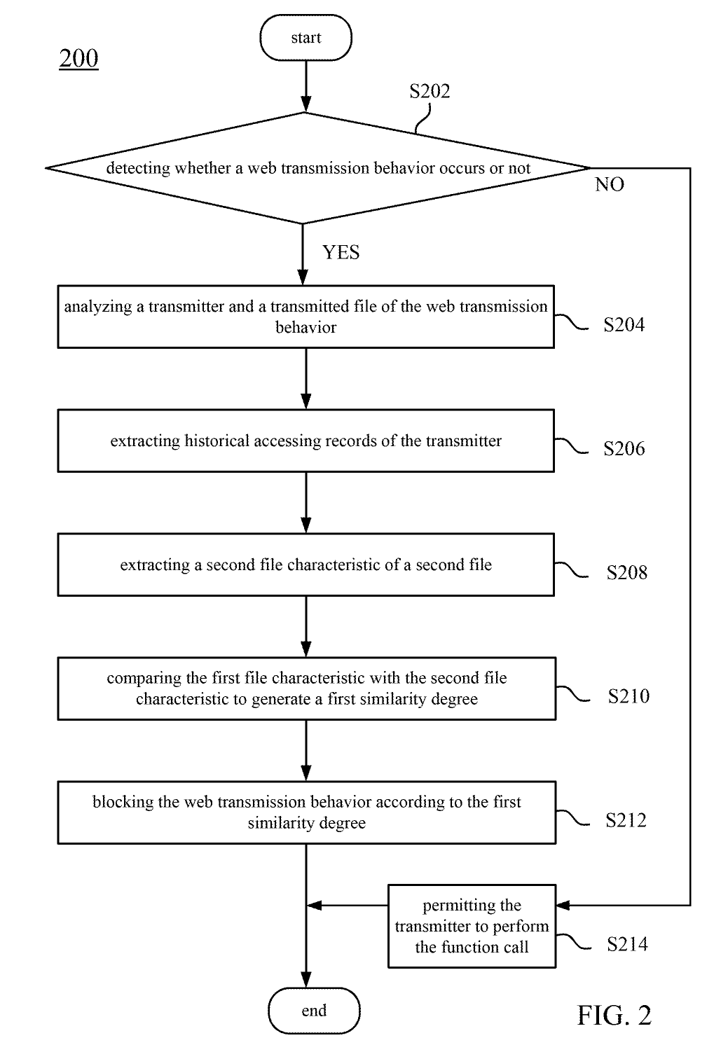

Reference is made to FIG. 2. FIG. 2 is a flow diagram illustrating a data protection method 200 according to some embodiments of this disclosure. For better understanding of the present disclosure, the data protection method 200 is discussed in relation to the data protection system 100 shown in FIG. 1, but is not limited thereto.

In step S202, the processor 120 detects whether a web transmission behavior occurs or not. In some embodiments, the tracer module 122 is configured to detect whether the application program APP_A is performing the web transmission behavior or not. For example, the application program APP_A transmits a file (such as, a first file F1) to another electronic device or another application program through the Internet.

In step S204, the processor 120 analyzes a transmitter and a transmitted file corresponding to the web transmission behavior. Taking the aforementioned embodiment as an example, the transmitter is the application program APP_A, the transmitted file is the above-mentioned first file F1, and the first file has a first file characteristic.

In step S206, the processor 120 extracts historical accessing records of the transmitter from the memory 140. Taking the aforementioned embodiment as an example, the tracer module 122 extracts a historical accessing record of the application program APP_A from the first memory unit 142. The historical accessing record is configured to record a plurality of accessing behaviors of the application program APP_A during a past time period. For example, the application program APP_A accesses at least one file (such as, a second file F2) of the application program APP_B during the past time period. In some embodiments, data of the application program APP_A and data of the application program APP_B are stored in different storing blocks of the memory 140 respectively. In other words, the application program APP_A accesses the data of the storing blocks corresponding to the application program APP_B.

In step S208, the processor 120 extracts a file characteristic (such as, a second file characteristic) of the aforementioned second file F2 from the memory 140. In some embodiments, the tracer module 122 extracts the file characteristics of all files of the application program APP_B from the second memory unit 144.

In step S210, the processor 120 compares the first file characteristic with the second file characteristic, to generate a first similarity degree. In some embodiments, if the first file characteristic is similar to the second file characteristic, the tracer 122 determines that the similarity degree is high. In some further embodiments, if M bytes of the first N bytes of the first file F1 is the same as M bytes of the first N bytes of the second file F2, and a ratio MIN is substantially equal to 80%, the tracer module 122 determines that the first similarity degree is 80%. In some embodiments, N and M are positive integers, and M is smaller than or is equal to N.

In step S212, the processor 120 blocks the web transmission behavior according to the first similarity degree. Taking the aforementioned embodiment as an example, if the tracer module 122 determines that the similarity degree between the first file and the second file is equal to or is larger than a threshold value (such as, 85%), the handler module 128 blocks the web transmission behavior of the application program APP_A. In other words, in a state that the first file F1 is very similar to the second file F2 (it is suspected that the application program APP_A steals the second file F2 from the application program APP_B), the handler module 128 prevents the application program APP_A from transmitting the first file F1, to protect the second file F2 of the application APP_B.

In step S202, if the processor 120 detects that no web transmission behavior performed by the application program APP_A, step S214 is entered.

In step S214, the processor 120 permits the transmitter to perform the function calls. Taking the aforementioned embodiment as an example, the processor 120 permits the application program APP_A to perform function calls to the application program interface 160. The function calls are corresponding to, for example, reading instructions, writing instructions, or various instructions.

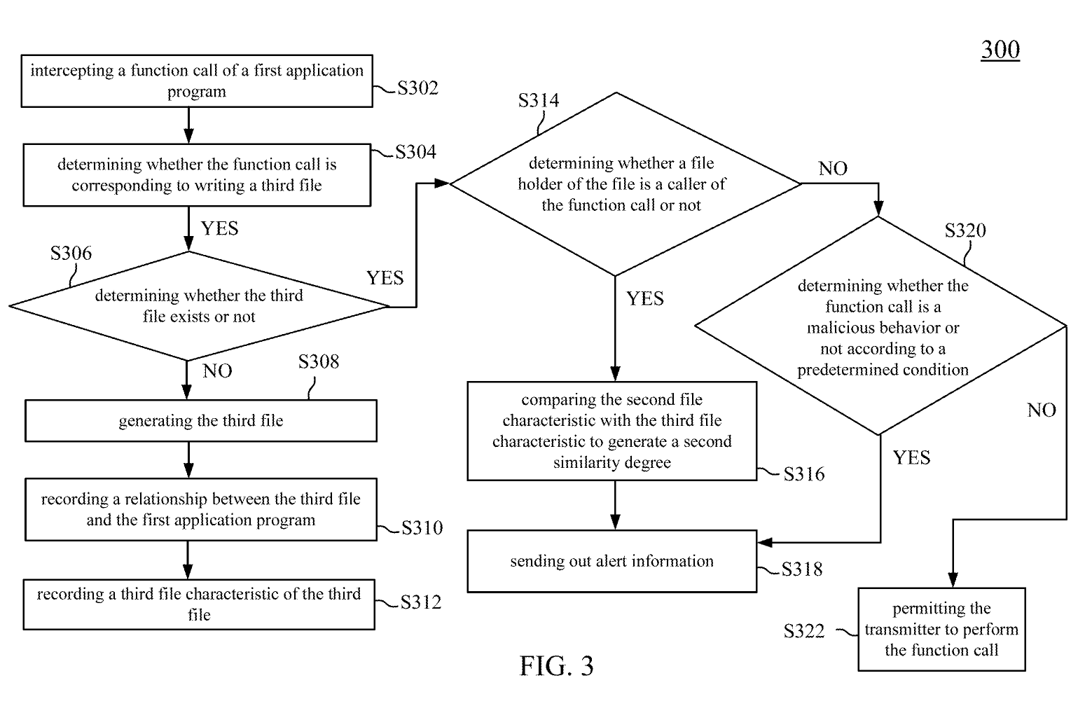

Reference is made to FIG. 3. FIG. 3 is a flow diagram illustrating a data protection method 300 according to some embodiments of this disclosure.

In step S302, the processor 120 intercepts the function call of the application program APP_A. In some embodiments, the interceptor module 124 is configured to the intercepts the function call of the application program APP_A for the application program interface 160.

In step S304, the processor 120 determines whether the function call is corresponding to writing a file (such as, a third file) or not. In some embodiments, the filter module 126 is configured to determine whether the intercepted function call is corresponding to writing the third file or not.

In step S306, the processor 120 determines whether the third file exists or not in a state that the function call corresponds to writing the third file. In some embodiments, the filter module 126 searches the memory 140 to determine whether the third file exists in the memory 140 or not.

In step S308, the processor 120 generates the third file in a state that the third file is inexistent. In some embodiments, since the function call is from the application APP_A, the application program APP_A generates a new file through the application program interface 160, to accomplish the function call. The new file is the third file.

In step S310, the processor 120 records a relationship between the third file and the application program APP_A, to generate the historical accessing record. In some embodiments, the filter module 126 records that the third file is generated by the application program APP_A, to form the historical accessing records of the application program APP_A. In some embodiments, the historical accessing records are stored into the first memory unit 142.

In step S312, the processor 120 records a third file characteristic of the third file. In some embodiments, the tracer module 126 analyzes the file characteristics of the third file. In some embodiments, the file characteristics of the third file are stored into the second memory unit 144.

In step S306, step S314 is entered in a state that the third file is existent.

In step S314, the processor 120 determines a file holder of the third file. In some embodiments, the tracer module 126 determines whether the file holder of the third file is the caller of the function call or not. Taking the aforementioned embodiments as an example, the holder of the third file is the application program APP_A, and the caller of the function call in step S302 is also the application program APP_A. Under this condition, the filter module 126 determines that the holder of the third file is the caller of the function call. Then, step S316 is entered.

In step S316, the processor 120 compares the second file characteristic with the third file characteristic, to generate a second similarity degree. In some embodiments, the filter module 126 compares the second file characteristic with the third file characteristic, to determine whether the third file generated by the application program APP_A is similar to the second file F2 of the application APP_B or not.

In step S318, the processor 120 sends out alert information according to the above-mentioned second similarity degree. In some embodiments, the handler module 128 sends out the alert information in a state that the similarity degree between the third file characteristic and the second file characteristic is equal to or is higher than a threshold value. In some embodiments, the alert information includes an e-mail, a pop-up window, or various notifications.

By the above-mentioned approach, the handler module 128 sends out the alert information in a state that the application program APP_A is suspected to steal the second file F2 from the application program APP_B, to achieve a purpose of alerting.

In step S314, in some embodiments, if the filter module 126 determines that the holder of the third file is not the caller of the function call, then step S320 is entered.

In step S320, the processor 120 determines whether the function call is a malicious behavior or not according to a predetermined condition. In some embodiments, the predetermined condition includes a file type of the third file. In some embodiments, a word file (such as, .txt file) is configured to record information which is more important. Accordingly, compared with a photo file type, a word file type is more important. Thus, in some embodiments, if the file type of the function call is corresponding to a word file type, the filter module 126 determines that the function call is the malicious behavior. Under this condition, the handler module 128 sends out the alert information (step S318). On the other hand, if the filter module 126 determines that the function call is not the malicious behavior, step S322 is entered. In step S322, the processor 120 permits the application APP_A to perform the function call to the application program interface 160.

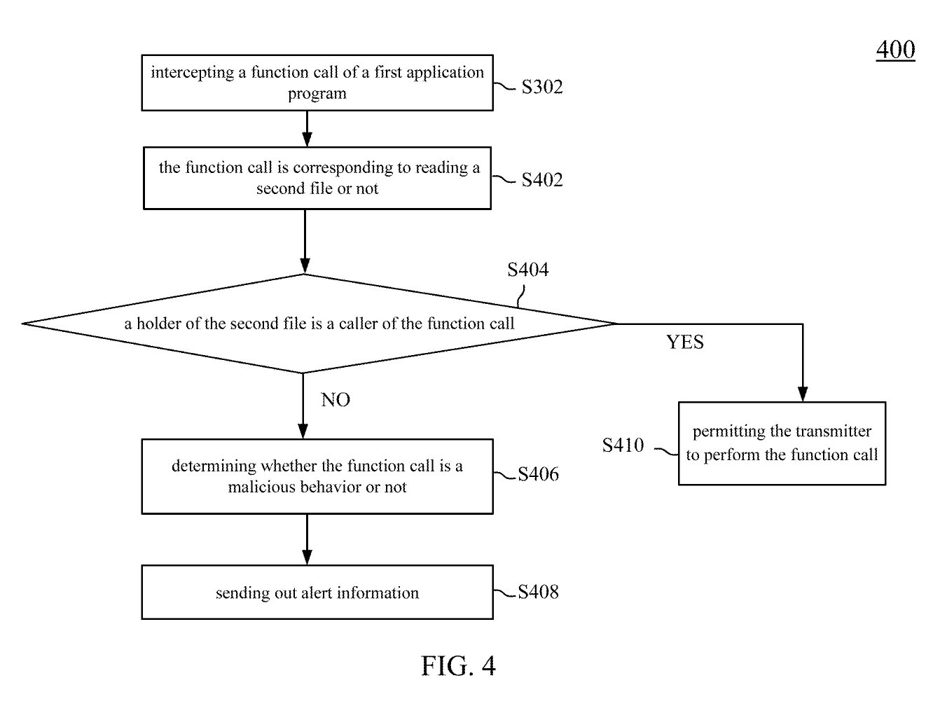

Reference is made to FIG. 4. FIG. 4 is a flow diagram illustrating a data protection method 400 according to some embodiments of this disclosure.

In step S302, the processor 120 intercepts a function call of the application program APP_A.

In step S402, the processor 120 determines whether the function call is corresponding to reading a file or not. In some embodiments, the filter module 126 determines whether the function call is that the application program APP_A reads a file (such as, the second file F2) of the application program APP_B or not.

In step S404, the processor 120 determines whether the holder of the second file F2 is a caller of the function call or not. Taking the aforementioned embodiment as an example, the holder of the second file F2 is the application program APP_B, but the caller of the function call is the application program APP_A. If the filter module 126 determines that the holder of the second file F2 is not the caller of the function call, step S406 is entered.

In step S406, the processor 120 determines whether the function call is a malicious behavior or not. Step S406 is similar to the aforementioned step S320, so is not described herein again.

In step S408, the processor 120 sends out alert information in a state that the function call is determined as the malicious behavior. Step S408 is similar to the aforementioned step S318, so is not described herein again.

In step S404, in some other embodiments, if the filter module 126 determines that the holder of the second file F2 is the caller of the function call, step S410 is entered. In step S410, the processor 120 permits the application program APP_A to perform the function call to the application program interface 160.

The above description of the data protection method 200, 300, or 400 includes exemplary operations, but the operations are not necessarily performed in the order described. The order of the operations of the data protection method 200, 300, or 400 disclosed in the present disclosure are able to be changed, or the operations are able to be executed simultaneously or partially simultaneously as appropriate, in accordance with the spirit and scope of various embodiments of the present disclosure.

In some embodiments, the data protection method 200, 300, or 400 may be implemented as a computer program and stored in a storing device. The storing device includes non-volatile computer-readable recording medium or other device with storing function. The computer program includes a plurality of program instructions. The CPU may execute the program instructions to perform functions of each module.

In some embodiments, the data protection system 100 is implemented to the mobile electronic device E. Accordingly, the data protection methods 200, 300, or 400 are configured to protect data in the mobile electronic device E.

As the above embodiments, in the data protection method and the data protection system of this disclosure, the processor compares the first file characteristic with the second file characteristic in a state that the web transmission behavior is detected. The processor blocks the web transmission behavior in a state that the first file characteristic is similar to the second file characteristic. Thus, the first file suspected to be the second file is prevented from being transmitted through the web by the first application program.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A data protection method, comprising:
detecting whether a web transmission behavior occurs or not by a processor;
analyzing a transmitter and a first file of the web transmission behavior by the processor, wherein the transmitter is corresponding to a first application program, and the first file is corresponding to a first file characteristic;
extracting a historical accessing record of the transmitter from a memory by the processor;
extracting a second file characteristic of a second file from the memory, by the processor, in a state that the historical accessing record indicates that the transmitter accesses the second file of a second application program;
comparing the first file characteristic with the second file characteristic, by the processor, to generate a first similarity degree; and
blocking the web transmission behavior according to the first similarity degree by the processor.

2. The data protection method of claim 1, wherein the first application program and the second application program are installed in a mobile electronic device.

3. The data protection method of claim 1, further comprising:
intercepting a function call of the first application program by the processor;
by the processor, determining whether the function call is corresponding to writing a third file or not;
determining whether the third file exists or not, by the processor, in a state that the function call is corresponding to writing the third file;
generating the third file, by the processor, in a state that the third file is inexistent;
recording a relationship between the third file and the first application program, by the processor, to generate the historical accessing record; and
recording a third file characteristic of the third file by the processor.

4. The data protection method of claim 3, further comprising:
determining a file holder of the third file, by the processor, in a state that the third file is existent;
comparing the second file characteristic with the third file characteristic, by the processor, in a state that the file holder is the first application program, to generate a second similarity degree; and
sending out first alert information according to the second similarity degree by the processor.

5. The data protection method of claim 4, further comprising:
determining whether the function call is corresponding to reading the second file or not by the processor;
determining whether the function call is a malicious behavior or not according to a predetermined condition, by the processor, in a state that the function call is corresponding to reading the second file, wherein the predetermined condition comprises a file type of the second file; and
sending out second alert information, by the processor, in a state that the function call is determined as the malicious behavior.

6. The data protection method of claim 5, further comprising:
determining the function call is the malicious behavior, by the processor, in a state that the file type is corresponding to a word file type.

7. A data protection system, comprising:
a memory; and
a processor coupled to the memory, wherein the processor is configured to detect whether a web transmission behavior occurs or not, the processor is further configured to analyze a transmitter and a first file of the web transmission behavior, the transmitter is corresponding to a first application program and the first file is corresponding to a first file characteristic, the processor is further configured to extract a historical accessing record of the transmitter from a memory, the processor is further configured to extract a second file characteristic of a second file from the memory in a state that the historical accessing record indicates that the transmitter accesses the second file of a second application program, the processor is further configured to compare the first file characteristic with the second file characteristic to generate a first similarity degree, and the processor is further configured to block the web transmission behavior according to the first similarity degree.

8. The data protection method of claim 7, wherein the processor is further configured to intercept a function call of the first application program, the processor is further configured to determine whether the function call is corresponding to writing a third file or not, the processor is further configured to determine whether the third file exists or not in a state that the function call is corresponding to writing the third file, the processor is further configured to generate the third file in a state that the third file is inexistent, the processor is further configured to record a relationship between the third file and the first application program, to generate the historical accessing record, and the processor is further configured to record a third file characteristic of the third file.

9. The data protection method of claim 8, wherein the processor is further configured to determine a file holder of the third file in a state that the third file is existent, the processor is further configured to compare the second file characteristic with the third file characteristic to generate a second similarity degree in a state that the file holder is the first application program, and the processor is further configured to send out first alert information according to the second similarity degree.

10. The data protection method of claim 9, wherein the processor is further configured to determine whether the function call is corresponding to reading the second file or not, the processor is further configured to determine whether the function call is a malicious behavior or not according to a predetermined condition in a state that the function call is corresponding to reading the second file, the predetermined condition comprises a file type of the second file, and the processor is further configured to send out second alert information in a state that the function call is determined as the malicious behavior.

11. The data protection method of claim 10, wherein the processor is further configured to determine the function call is the malicious behavior in a state that the file type is corresponding to a word file type.

12. A non-transitory computer readable storage medium storing a computer program, wherein the computer program is configured to execute a data protection method, and the data protection method comprises:
detecting whether a web transmission behavior occurs or not;
analyzing a transmitter and a first file of the web transmission behavior, wherein the transmitter is corresponding to a first application program, and the first file is corresponding to a first file characteristic;
extracting a historical accessing record of the transmitter from a memory;
extracting a second file characteristic of a second file from the memory in a state that the historical accessing record indicates that the transmitter accesses the second file of a second application program;
comparing the first file characteristic with the second file characteristic to generate a first similarity degree; and
blocking the web transmission behavior according to the first similarity degree.

13. The non-transitory computer readable storage medium of claim 12, wherein the first application program and the second application program are installed in a mobile electronic device.

14. The non-transitory computer readable storage medium of claim 12, wherein the data protection method further comprises:
intercepting a function call of the first application program;
determining whether the function call is corresponding to writing a third file or not;
determining whether the third file exists or not in a state that the function call is corresponding to writing the third file;
generating the third file in a state that the third file is inexistent;
recording a relationship between the third file and the first application program, to generate the historical accessing record; and
recording a third file characteristic of the third file.

15. The non-transitory computer readable storage medium of claim 14, wherein the data protection method further comprises:
determining a file holder of the third file in a state that the third file is existent;
comparing the second file characteristic with the third file characteristic in a state that the file holder is the first application program, to generate a second similarity degree; and
sending out first alert information according to the second similarity degree.

16. The non-transitory computer readable storage medium of claim 15, wherein the data protection method further comprises:
determining whether the function call is corresponding to reading the second file or not;
determining whether the function call is a malicious behavior or not according to a predetermined condition in a state that the function call is corresponding to reading the second file, wherein the predetermined condition comprises a file type of the second file; and
sending out second alert information in a state that the function call is determined as the malicious behavior.

17. The non-transitory computer readable storage medium of claim 16, wherein the data protection method further comprises:
determining the function call is the malicious behavior in a state that the file type is corresponding to a word file type.
